(19) United States
(12) Patent Application Publication
(10) Pub. No.: US 2008/0143692 A1
(43) Pub. Date: Jun. 19, 2008

(54) Method and System for Recognising Handwritten Data

(75) Inventor: Shekhar Ramachandra Borgaonkar, Kamataka (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/883,183

(22) PCT Filed: Feb. 23, 2005
(86) PCT No.: PCT/IN05/00060

§ 371 Date: Jul. 27, 2007

(51) Int. Cl. G06F 3/033; G09G 3/36

(52) U.S. Cl. 345/179; 345/104

(57) ABSTRACT

A system for recognizing handwritten data is provided. The system includes an electronic pen and a computing device. The electronic pen is used for forming handwritten data on a medium and for generating an electronic form of the handwritten data. The computing device is used for recognizing the handwritten data based on the electronic form of the handwritten data. The computing device is programmable to generate at least one alternative handwritten data and allows a user to select the at least one alternative handwritten data to replace the recognized handwritten data.

### FIELD OF THE INVENTION

The invention relates generally to electronically recording of handwritten data, and more particularly to a system and method for recognizing handwritten data using an electronic pen.

### BACKGROUND OF THE INVENTION

With the widespread use of computers, telecommunication devices and other electronic devices, documents are normally stored, transmitted and displayed in electronic form. In order to store, transmit and display the documents in electronic form, written data of the documents have to be scanned or entered into the computer manually. This makes the converting of the documents into electronic form cumbersome and inconvenient.

To allow conversion of written data directly into electronic form without scanning them or entering the information into the computer manually, an electronic pen can be used. The electronic pen allows a user to write on a medium, such as paper, and capture what was written electronically. The electronic pen usually includes a position sensor to detect a position of the pen at different instances. Such position information of the pen is subsequently translated into pen movements or strokes.

When the written data correspond to a written language, a handwriting recognition algorithm may be used to recognize the written data when converting them into electronic form. However, existing handwriting recognition algorithms are prone to errors, resulting in the written data to be incorrectly recognized. The errors in the recognized written data may be corrected by typing the correct written data directly in the computer. Alternatively, the written data errors may be corrected by overwriting the incorrect written data on the medium with the correct written data.

However, overwriting the incorrect written data smudges the medium. This results in the written data on the medium to be messy and intelligible. In some applications such as filling an insurance application document, it is a legal requirement to maintain a clean and error-free hardcopy of the document containing the written data or information. A hardcopy document containing ink smudges due to overwriting does not meet the legal requirement.

It is desirable to provide a system and a method that allows a user to correct any errors of recognized written data without smudging the document containing the written data.

### SUMMARY OF THE INVENTION

In an embodiment, a system for recognizing handwritten data is provided. The system includes an electronic pen and a computing device. The electronic pen is used for forming handwritten data on a medium and for generating an electronic form of the handwritten data. The computing device is used for recognizing the handwritten data based on the electronic form of the handwritten data. The computing device is programmable to generate at least one alternative handwritten data and allows a user to select the at least one alternative handwritten data to replace the recognized handwritten data.

### BRIEF DESCRIPTION OF THE DRAWINGS

The embodiments of the invention will be better understood in view of the following drawings and the detailed description.

FIG. 1 shows an electronic pen according to an embodiment of the invention.

FIG. 2 shows a flow chart for recognizing handwritten data according to an embodiment of the invention.

FIG. 3 shows the handwritten data on a paper and a corresponding display of the recognized handwritten data having an incorrectly recognized character with four alternative characters according to an embodiment of the invention.

FIG. 4 shows the selecting of one of the four alternative characters by tapping at a corresponding position of the paper using the electronic pen according to an embodiment of the invention.

FIG. 5 shows that the incorrectly recognized character has been replaced with the selected alternative character according to an embodiment of the invention.

### DETAILED DESCRIPTION OF THE INVENTION

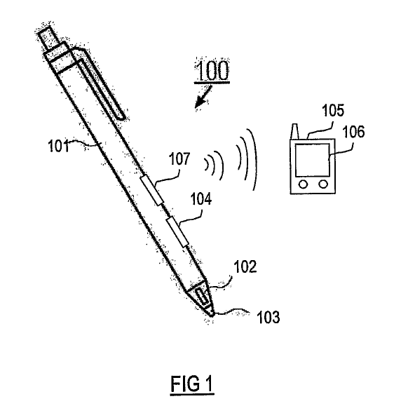

FIG. 1 shows an electronic pen 100 according to an embodiment. The electronic pen 100 includes a housing 101, a position sensing unit 102, an ink tip 103 and a processor 104 arranged inside the housing 101.

The position sensing unit 102 is mounted near the ink tip 103 of the electronic pen 100. In an embodiment, the position sensing 102 unit is a signal transmitter which transmits a position signal to a position signal sensor or receiver (not shown). The receiver is placed at a fixed location, for example clipped to a medium the electronic pen writes on, outside the electronic pen 100. The receiver determines a position of the electronic pen 100 based on the received position signal. It is also possible that the receiver transmits the received position signal to another device for determining the position of the electronic pen 100.

The ink tip 102 of the electronic pen 100 is used for forming marks or handwritten data on the medium. An ink forming element (not shown) housed inside the pen housing 101 normally supplies ink to the ink tip 102. Examples of an ink forming element include but not limited to ink cartridges and any kind of ink refills for ball-point pens. The handwritten data is formed on the medium when a user writes on the medium using the electronic pen 100. As the user moves the pen 100 over the medium with the ink tip 102 contacting the medium, ink flows from the ink forming element through the ink tip 102 onto the medium. Accordingly, the handwritten data is formed. The handwritten data refers to any markings formed on the medium by the electronic pen 100. Such markings include any kind of handwritings, scribbles and drawings.

In an embodiment, the position sensing unit 102 includes an electromagnetic signal transmitter. The electromagnetic signal transmitter transmits an electromagnetic signal as the position signal. In another embodiment, the position sensing unit 102 is an acoustic signal transmitter. The acoustic signal transmitter transmits an acoustic signal as the position signal. An example of the acoustic signal transmitter is an ultrasonic signal transmitter which transmits an ultrasonic signal as the position signal.

In an embodiment, the position sensing unit 102 is an optical sensor. The optical sensor scans a portion of the medium containing a portion of the handwritten data. The scanned image of the medium is processed by the processor to determine the position of the pen on the medium. Based on the determined position of the pen, the electronic form of the handwritten data is generated.

The processor 104 is housed within the housing 101 of the electronic pen 100. The processor 104 is adapted to process the detected position of the pen 100. The processor 104 may be implemented using a Signal Processor (DSP) chip. The detected position of the pen 100 is processed to determine the movement of the pen 100, and hence, an electronic form of the handwritten data.

A computing device 105 is used together with the electronic pen 100 for recognizing the handwritten data. The computing device 105 recognizes the handwritten data based on the electronic form of the handwritten data generated by the electronic pen 100. In an embodiment, the computing device 105 recognizes the handwritten data using a language model, such as English. It is also possible for the computing device 105 to recognize the handwritten data using other language models such as Japanese, Chinese, Hindi or German in other embodiments. The computing device 105 may be programmed to allow the user to select a desired language model for recognizing the handwritten data.

The computing device 105, in addition to recognizing the handwritten data, is programmed to generate one or more alternative handwritten data. The alternative handwritten data that has a high probability of being correct is displayed on the display unit. If the recognized handwritten data is incorrect, a user is able to select the alternative handwritten data to replace the recognized handwritten data as the correct handwritten data. In an embodiment, the recognized handwritten data and the alternative handwritten data are displayed on a display unit 106 for the user to view them. The display unit 106 may be a liquid crystal display (LCD) or a cathode ray tube (CRT) monitor.

The computing device 105 may be any device which has computing capabilities. Examples of devices suitable to be used as the computing device 105 are personal digital assistants (PDA) and computers.

In an embodiment, the electronic pen 100 includes a connection means 107 for transferring data from the electronic pen 100 to the computing device 105. The computing device 105 upon receiving the data may further process the received data and display the processed data, i.e. the recognized handwritten data and the alternative handwritten data, on the display unit 106. In one embodiment, the connection means 107 connects to the computing device 105 using a wireless connection such as radio frequency (RF) or Infrared. An example of a RF connection means is Bluetooth. In another embodiment, the connection means 107 connects to the computing device 105 using a wired connection such as a serial port, a parallel port or a Universal Serial Bus (USB).

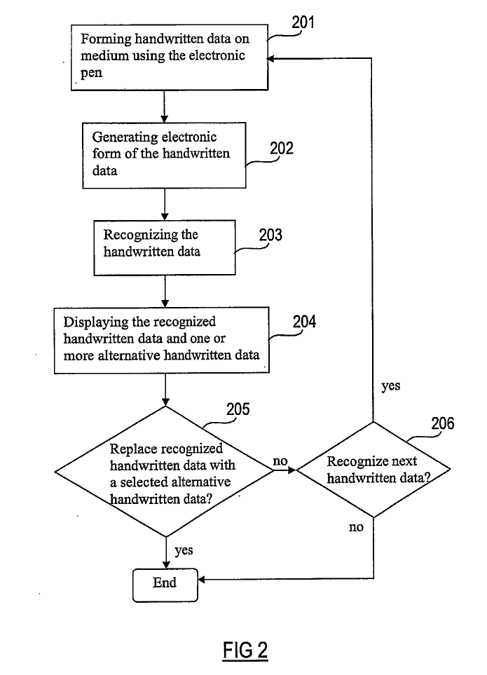

FIG. 2 shows a flow chart for a process of recognizing handwritten data using the electronic pen according to an embodiment. Step 201 includes forming handwritten data on medium using the electronic pen. When a user writes on the medium using the electronic pen, ink is deposited onto the medium to form the handwritten data.

Step 202 includes generating an electronic form of the handwritten data. As the handwritten data is formed on the medium by moving the pen over the medium, the position of the pen on the medium is sensed by the position sensing unit. The sensed or detected position of the pen is processed by the processor of the electronic pen to determine the movement or strokes of the pen. The pen movement or pen strokes correspond to the electronic form of the handwritten data. The electronic form of the handwriting is normally referred as the electronic ink. The electronic ink is transferred to a computing device.

Step 203 includes recognizing the handwritten data by the computing device based on the electronic ink. The computing device recognizes the handwritten data using a language model. The language model is based on any language including, but not limited to, English, Chinese, Japanese, Hindi and Korean. The computing device may recognize a single character or a whole word of the handwritten data.

The computing device first collects samples of the electronic ink of the characters and words in all the language models during a learning phase, and stores them. During the recognizing process, the computing device compares the electronic ink corresponding to the handwritten data with the stored electronic ink of the sample characters or words. The best match from the comparison is determined as the recognized handwritten data, and the next closest matches are determined as alternative handwritten data.

Step 204 includes displaying the recognized handwritten data and one or more alternative handwritten data. The handwritten data are displayed on a display unit such as a Liquid Crystal Display (LCD) or a Cathode Ray Tube (CRT) monitor. If the computing device recognizes the handwritten data character by character, one or more alternative characters are displayed as alternative handwritten data for each recognized character. If the computing device recognizes the handwritten data word by word, one or more alternative words are displayed as alternative handwritten data for each recognized word.

Step 205 includes allowing a user to replace the recognized handwritten data with a selected alternative handwritten data. When the handwritten data is wrongly recognized by the computing device, a user is able to select an alternative handwritten data to replace the wrongly recognized handwritten data.

Step 206 includes determining whether a next handwritten data is to be recognized. If a next handwritten data is to be recognized, step 201 to step 205 are repeated. Otherwise, the process of recognizing the handwritten data is complete.

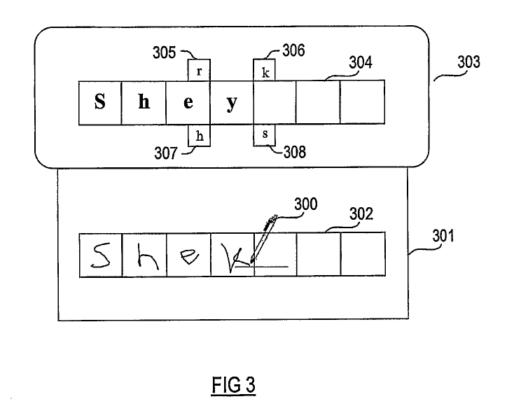

The electronic pen 100 and the computing device 105 can be used in a form filling application as a handwritten data recognition system in an embodiment. In this embodiment, a form is filled up by a user using the electronic pen 100 in spaces provided in a form. According to this embodiment, information written on the form can be directly captured into electronic form without having to re-enter the information into a computer. The use of the electronic pen 100 and the computing device 105 in the form filling application can be illustrated using an example as shown from FIG. 3 to FIG. 5.

FIG. 3 shows a form 301 having a field 302 for filling handwritten data using an electronic pen 300. A display screen 303 having a corresponding field 304 for displaying the recognized handwritten data is also shown. A computing device (not shown) recognizes the handwritten data character by character. A user attempts to write “SHEK” in the field 302. As can be seen in FIG. 3, the computing device has recognized the first three letters “S”, “H” and “E” correctly. However, the last letter “K” was incorrectly recognized as “Y” as seen in the field 304 of the display screen 303. In addition, four alternative handwritten data 305, 306, 307, 308 are displayed. It should be noted that it is possible to have any other numbers of alternative handwritten data instead of four in other embodiments.

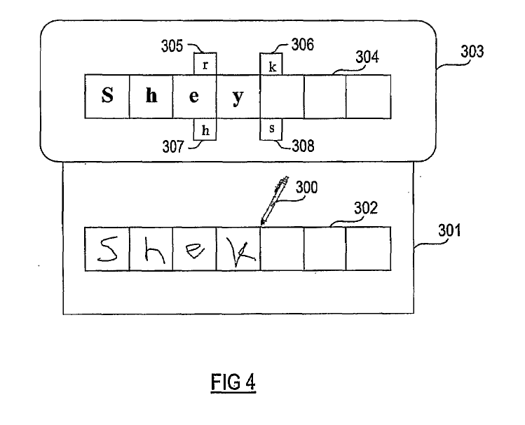

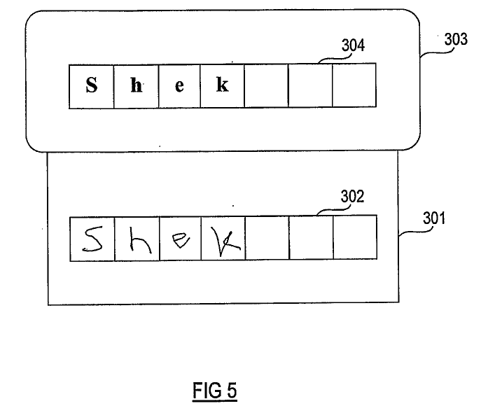

FIG. 4 shows the user tapping the electronic pen 300 at the top right hand corner of the last character “CK”. The top right hand corner of “K” corresponds to the alternative handwritten data 306 “K” in the field 304 of the display screen 303. Accordingly, the last character in the field 304 of the display screen 303 is replaced with the alternative handwritten data 306 “K” selected by the user as shown in FIG. 5.

It should be noted that if none of the alternative handwritten data are the correct handwritten data, the user may need to overwrite the handwritten data on the medium. In this case, the computing device recognizes the handwritten data and responds with corresponding alternative handwritten data, which may be new or those which were previously displayed, for selection by the user.

The recognizing of handwritten data described in the above-mentioned embodiments allows any incorrectly recognized handwritten data to be corrected without overwriting the handwritten data on the medium. Therefore, smudging of the medium when correcting the recognized handwritten data is minimized.

Although the present invention has been described in accordance with the embodiments as shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A system for recognizing handwritten data, the system comprising:
an electronic pen for forming handwritten data on a medium and generating an electronic form of the handwritten data;
a computing device for recognizing the handwritten data based on the electronic form of the handwritten data,
wherein the computing device is programmable to generate at least one alternative handwritten data and allows a user to select the at least one alternative handwritten data to replace the recognized handwritten data.

2. The system of claim 1, wherein the computing device comprises a display unit for displaying the recognized handwritten data and the at least one alternative handwritten data.

3. The system of claim 2, wherein the display unit is a Liquid Crystal Display (LCD).

4. The system of claim 1, wherein the electronic pen comprises:
an ink tip for forming handwritten data on the medium;
a position sensing unit for detecting a position of the pen when the handwritten data is formed; and
a processor for processing the detected position of the pen, thereby generating the electronic form of the handwritten data.

5. The system of claim 4, wherein the position sensing unit comprises an electromagnetic signal transmitter for transmitting a position signal to an electromagnetic signal receiver.

6. The system of claim 4, wherein the position sensing unit comprises an acoustic signal transmitter for transmitting a position signal to an acoustic signal receiver.

7. The system of claim 4, wherein the position sensing unit comprises an optical sensor for obtaining at least an optical image of a portion of the handwritten data and the medium.

8. The system of claim 4, wherein the electronic pen further comprises a connection means for transferring the electronic form of the handwritten data to the computing device.

9. The system of claim 8, wherein the connection means is at least one of the following:
a Universal Serial Bus;
an Infrared connection; and
a Bluetooth connection.

10. The system of claim 1, wherein the computing device is a personal digital assistant (PDA).

11. The system of claim 2, wherein the computing device is programmable to display four alternative handwritten data.

12. The system of claim 11, wherein the four alternative handwritten data are arranged at four corners around the recognized handwritten data.

13. The system of claim 1, wherein the computing device is programmable to recognize the handwritten data using a language model.

14. The system of claim 13, wherein the computing device is programmable to allow the user to select another language model for recognizing the handwritten data.

15. The system of claim 1, wherein the system is used in a form filling system for recognizing handwritten data.

16. A method for recognizing handwritten data, comprising:
forming handwritten data on a medium using an electronic pen;
generating an electronic form of the handwritten data;
recognizing the handwritten data based on the electronic form of the handwritten data;
displaying the recognized handwritten data and at least one alternative handwritten data;
replacing the recognized handwritten data with the at least one alternative handwritten data when the at least one alternative handwritten data is selected.

17. A program storage device readable by a computing device, tangibly embodying a program of instructions, executable by the computing device to perform a method for recognizing handwritten data, the method comprising:
generating an electronic form of the handwritten data on a medium;
recognizing the handwritten data based on the electronic form of the handwritten data;
displaying the recognized handwritten data and at least one alternative handwritten data;
replacing the recognized handwritten data with the at least one alternative handwritten data when the at least one alternative handwritten data is selected.
